(19) United States
(12) Patent Application Publication
(10) Pub. No.: US 2025/0148329 A1
(43) Pub. Date: May 8, 2025

(54) FLOATING POINT QUANTIZATION FOR REDUCED QUANTUM SIMULATION FOOTPRINT

(71) Applicant: Dell Products L.P., Round Rock, TX (US)

(72) Inventors: Brendan Burns Healy, Haddonfield, NJ (US); Benjamin E. Santaus, Somerville, MA (US); Rômulo Teixeira de Abreu Pinho, Niterói (BR)

(21) Appl. No.: 18/345,146

(22) Filed: Jun. 30, 2023

Related U.S. Application Data
(60) Provisional application No. 63/383,348, filed on Nov. 11, 2022.

(51) Int. Cl. G06N 10/20; G06F 17/16

(52) U.S. Cl. CPC G06N 10/20; G06F 17/16

(57) ABSTRACT

One example method includes obtaining, for a quantum gate of a quantum circuit, an estimate of a distribution of values expected to result from a matrix multiplication relating to the quantum gate, applying a binning process to the distribution to generate a bin table, quantizing an FP value of the matrix multiplication by mapping the bin table to a bin index that corresponds to the FP value, storing the bin index, and performing the matrix multiplication using the bin index.

### FIELD OF THE INVENTION

Some embodiments of the present invention generally relate to quantum computing. More particularly, at least some embodiments of the invention relate to systems, hardware, software, computer-readable media, and methods, for FP quantization for reduced quantum simulation footprint.

### BACKGROUND

Due to the still limited availability of quantum computers and to constraints of NISQ (noisy intermediate-scale quantum) devices, quantum simulation engines running on classical infrastructures will continue to have an important role to play in the evaluation of quantum algorithms, and on the improvement of quantum devices themselves. Nonetheless, running quantum algorithms on simulation engines is limited by the number of classical resources available. This is especially the case with RAM (random access memory), since the memory consumption of quantum algorithms grows exponentially with the number of qubits used by the algorithms. Even the largest HPC (high performance compute) infrastructures available can only run algorithms with up to a few dozen qubits.

In general, quantum algorithms comprise a series of floating-point (FP) matrix multiplications, or gates, that transform qubit states. One approach to address memory consumption in operations with large matrices is quantization. GPUs (graphical processing unites), for example, offer quantization options that allow 32-bit FPs to be represented with 8-bit integers.

On the one hand, quantizing FP numbers may be as straightforward as choosing the type of variables in source code, or setting a parameter of a mathematical library. However, such settings affect all subsequent computations. Thus, if the quantization is too aggressive, that is, with small numerical types, precision is compromised because FP precision errors are cumulative. If the quantization is too conservative, there is little benefit in terms of memory consumption with, possibly, additional computational cost.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying Figures.

FIG. 1 discloses an example quantum circuit DAG with an expected FP value distribution at the DAG nodes.

FIG. 2 discloses an example quantization function according to one example embodiment.

FIG. 3 discloses an example approach for obtaining estimates of referred FP value distributions.

FIG. 4 discloses aspects of an example training procedure that employs a loss function.

FIG. 5 discloses a method according to one example embodiment.

FIG. 6 discloses a computing entity configured and operable to perform any of the disclosed methods, processes, and operations.

### DETAILED DESCRIPTION OF SOME EXAMPLE EMBODIMENTS

Some embodiments of the present invention generally relate to quantum computing. More particularly, at least some embodiments of the invention relate to systems, hardware, software, computer-readable media, and methods, for FP quantization for reduced quantum simulation footprint.

In general, an embodiment of the invention may comprise an intelligent and adaptive quantization scheme that leverages patterns of the outcomes of matrix operations in quantum circuits. By doing this, an embodiment may enable the use of quantum algorithms with higher qubit counts, but at relatively small computation and precision costs, and possibly reduced memory consumption.

Further information concerning one or more example embodiments of the invention is disclosed in Appendix A hereto. Appendix A forms a part of this disclosure and is incorporated herein in its entirety by this reference.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that memory consumption may be managed in a way that enables operations using relatively large matrices. An embodiment may enable efficient and effective use of quantum simulation engines running on classical infrastructures. An embodiment may enable the running of quantum algorithms with higher qubit counts, but at relatively small computation and precision costs, and possibly reduced memory consumption. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Introduction

In general, some embodiments of the invention are concerned with FP quantization for a reduced quantum simulation footprint. Due to the still limited availability of quantum computers and to constraints of NISQ (noisy intermediate-scale quantum) devices, quantum simulation engines running on classical infrastructures will continue to have an important role to play in the evaluation of quantum algorithms and on the improvement of quantum devices themselves. Nonetheless, running quantum algorithms on simulation engines is limited by the number of classical resources available. This is especially the case with RAM (random access memory), since the memory consumption of quantum algorithms grows exponentially with the number of qubits used by the algorithms. Even the largest HPC (high performance compute) infrastructures available can only run algorithms with up to a few dozen qubits.

In general, quantum algorithms comprise a series of floating-point (FP) matrix multiplications (gates) that transform qubit states. One approach to address memory consumption in operations with large matrices is quantization. GPUs (graphics processing units), for example, already offer quantization options that allow 32-bit FPs to be represented with 8-bit integers.

Thus, some example embodiments comprise an intelligent, adaptive quantization scheme that leverages patterns of the outcomes of matrix operations in quantum circuits. By doing this, an embodiment may enable quantum algorithms with higher qubit counts at relatively small computation and precision costs.

### B. General Aspects of Some Example Embodiments

On the one hand, quantizing FP (floating point) numbers is as straightforward as choosing the type of variables on source code or setting a parameter of a mathematical library. However, such settings affect all computations henceforth. If the quantization is too aggressive, that is, with small numerical types, precision is compromised because FP precision errors are cumulative. If it is too conservative, there is little benefit in terms of memory consumption with, possibly, additional computational cost.

Thus, one or more example embodiments comprise a method that is based on modelling the distributions of FP values that result from matrix multiplication, that is, quantum gate operations. Namely, for each quantum gate on a circuit directed acyclic graph (DAG) representation, an embodiment may operate to obtain, prior to execution of the circuit on a simulation engine, an estimate of the distribution of values that will result from the related matrix multiplication.

### C. Detailed Description

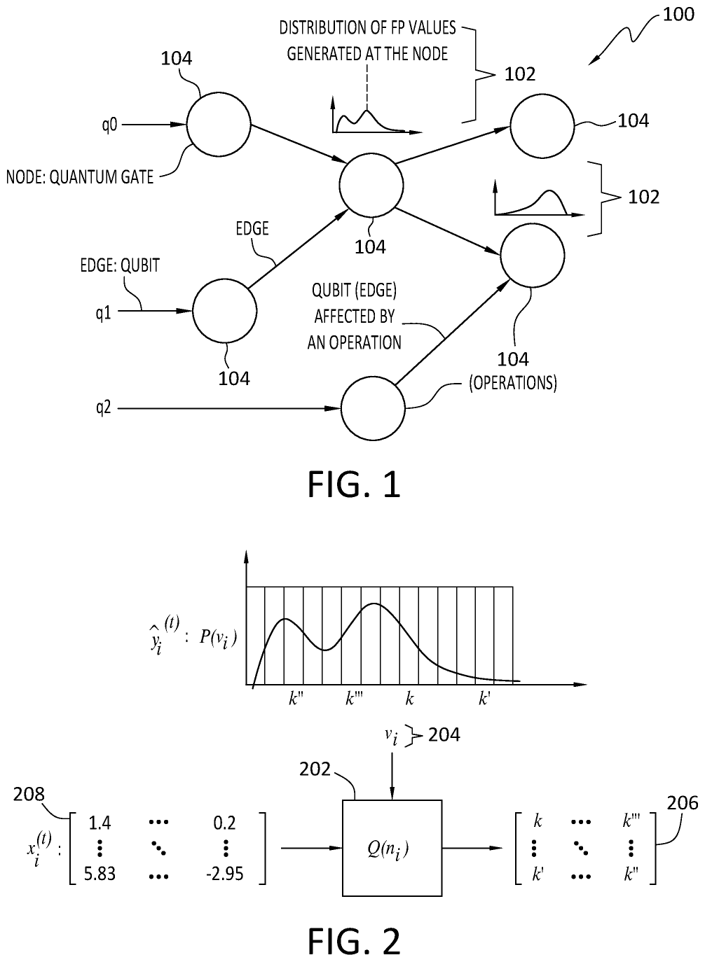

With reference now to FIG. 1, a circuit DAG 100 with expected FP value distribution, or simply ‘distribution,’ 102 at nodes 104 is disclosed. In particular, FIG. 1 discloses a circuit DAG 100 G=(N,E), where a vertex n E N corresponds to a gate, and an edge e∈E into n corresponds to a qubit dependency of that gate. As shown, each edge may correspond to a qubit that is affected by an operation, represented by a node 104.

As shown in the example of FIG. 1, and with reference now to FIG. 2 as well, the distributions 102 on the nodes 104 may be represented by histograms with some binning strategy. Reference is now made to FIG. 2 as well, which discloses a quantization function Q(nᵢ) which may be implemented by a quantization module 202 converting FP values 204 to integer bin indices 206 of a discrete distribution of a node nᵢ. Particularly, the bins of each distribution 102 may, as shown in FIG. 2, create mappings that may enable an embodiment to convert, that is, quantize, FP values v 204 in the computation of a gate matrix 208 multiplication to integer bin indices k 206. Similarly, bin indices 206 may be converted, or dequantized, to a representative FP value 204 of the corresponding bin when they need to be part of a computation such as, for example, the mean or median value of the bin.

For this to be achieved, each matrix multiplication function within the simulation engine may be modified to have a quantizer module Q(nᵢ) 202 that applies the quantization function Q(nᵢ) and dequantization functions associated with node nᵢ 104 of the DAG 100. The number of bins of the mapping may be distribution-dependent, and each distribution may have its own number of bins.

In a quantization process according to one example embodiment, the bin indices may occupy very little memory space, as compared with the space required for FP values. For example, 8-bit integers are equivalent to ¼ of 32-bit FP values and have a representation capacity of 256 bins, or 256 full precision FP values. Nonetheless, the actual matrix computations may be performed with the full precision FP values representative of the bins, which may be obtained in real time by the quantizer module Q 208.

Thus, in an embodiment, only the matrix items required during the matrix multiplication, for example a row of one matrix and a column of another matrix, may reside as full precision FP values in memory. If, in an embodiment, the values in all matrices in a circuit DAG were represented with, for example, 8-bit indices, the memory footprint of the computation would potentially reduce by a 4× factor, as compared to 32-bit FPs. This would be equivalent to allowing 2 additional qubits on simulated quantum circuits, which is equivalent a 4× increase in quantum information representation capacity.

Thus, an embodiment may enable the simulation of relatively larger quantum circuits while maintaining a corresponding memory requirement at a level associated with a relatively smaller quantum circuit. Put another way, an embodiment may operate such that larger quantum circuits may be accommodated, in a simulation, without an attendant increase in memory requirement that, in a conventional approach, would otherwise be required for such larger quantum circuits.

In an embodiment, the more bins used, the more precise the quantization may be, with some additional computation cost for storing larger bin tables. However, the computation cost is generally the same, regardless of the size of the larger bin tables, since (de)quantization may amount to accessing the bin tables in O(1) time.

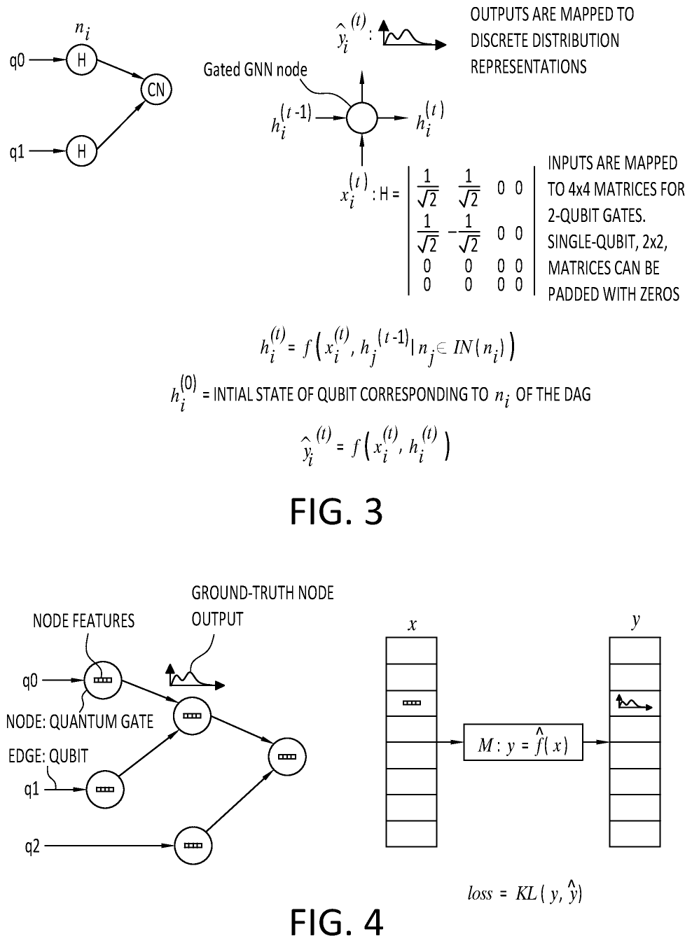

Turning next to the examples of FIGS. 3 and 4, a question which may arise is “how to obtain estimates of the referred FP value distributions?” In light of this, and with particular reference now to the example of FIG. 3, an embodiment may operate to train a Gated Graph Sequence Neural Network (GGS-NN) model that captures the relationship between inputs of a node of a quantum circuit DAG, and measured distributions obtained from several executions of circuit DAGs on a quantum simulation engine at full FP precision.

In general, GGS-NNs learn recurrent relationships between nodes of a graph, like Recurrent Neural Networks (RNNs) or Long Short-term Memory (LSTM) models, by unrolling graph connections into sequences with a pre-defined number of steps. Then, the inputs at each step t comprise annotations, or features (see ‘node features’ in FIG. 4), of the node x^{(t)} and a hidden state h^{(t-1)} that has been recurrently propagated from previous steps. As shown in the example of FIG. 3, each step yields an output ŷ^{(t)} and another hidden state h^{(t)} which is propagated to the next step. As disclosed in FIG. 3, the hidden state hᵢ^{(t)} of a node nᵢ is a function of the input and of the hidden states of all incoming neighbors according to the DAG, as follows:

$${h}_{i}^{( t )} = f ( {x}_{i}^{( t )} , {h}_{j}^{( t - 1 )} \vert {n}_{j} ∈ IN ( {n}_{i} ) )$$

As shown in the example of FIG. 3, one or more embodiments of the invention may operate to model the inputs of node nᵢ at step t, xᵢ^{(t)} as 4×4 matrices corresponding to 2-qubit quantum gates represented by nᵢ. In this example, single-qubit gates, represented by 2×2 matrices, are padded with zeros. For example, a single-qubit Hadamard gate H will have the following form:

$${x}_{i}^{( t )} : H = \vert \begin{matrix}\frac{1}{\sqrt{2}} & \frac{1}{\sqrt{2}} & 0 & 0 \\ \frac{1}{\sqrt{2}} & - \frac{1}{\sqrt{2}} & 0 & 0 \\ 0 & 0 & 0 & 0 \\ 0 & 0 & 0 & 0\end{matrix} \vert$$

An embodiment may also model the initial hidden state of nᵢ, hᵢ⁽⁰⁾, as the initial state of the qubit associated with that node of the DAG.

From there, and with reference now to FIG. 4 as well, an embodiment of the invention may operate to train a machine learning model that, as disclosed earlier herein, may yield an estimate ŷᵢ^{(t)} of the distribution of values of the matrix operation associated with node nᵢ of the DAG (see, e.g., DAG 100 in FIG. 1). In an embodiment, the training procedure may employ a loss function that measures the Kullbeck-Leibler (KL) divergence between the estimated distribution ŷᵢ^{(t)} and the real, measured, distribution y after running the DAG circuit several times.

In an embodiment, at inference time, and before executing a new circuit (DAG) on the simulation engine, the circuit may be rolled out into sequences of steps, possibly with the same number of steps as during training, and estimates of FP value distributions may be obtained for each node. Those distributions may then be provided to the simulation engine as bin tables so that the aforementioned quantizer can use them to transform FP values into bin indices and vice-versa.

### D. Further Discussion

One or more embodiments of the invention may possess various useful features and aspects. Following is a non-exhaustive list of examples. As will be apparent from this disclosure, one or more embodiments may possess various useful features and aspects. A non-exhaustive list of examples of such features and aspects follows. For example, an embodiment may comprise an adaptive FP quantization scheme for quantum computing simulations. Further, an embodiment may comprise a graph-based prediction engine that estimates the distribution of values at every node of a quantum circuit DAG. As another example, an embodiment may comprise a binning mechanism that replaces FP values with their 8-bit integer bin indices, or more, depending on the precision requirements. Finally, an embodiment may comprise a look-up table mechanism that converts bin indices to a selected FP value representative of the bin, and vice-versa.

### E. Example Methods

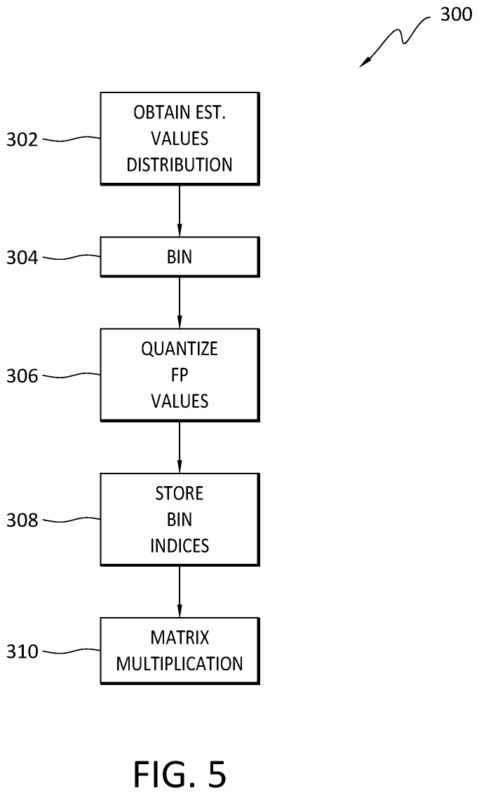

It is noted with respect to the disclosed methods, including the example method of FIG. 5, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

With attention now to FIG. 5, a method according to one example embodiment is denoted generally at 300. In an embodiment, the method 300, which may comprise part or all of a simulation of the execution of a quantum circuit on classical computing hardware, may be performed in whole or in part by, and/or at the direction of, a classical computing infrastructure on which a quantum circuit is able to run. In an embodiment, the method 300 may be performed prior to such a simulation.

The method 300 may begin with obtaining 302 an estimate of a distribution of values that will result from a matrix multiplication, that is, the values that will result when a gate of a quantum circuit is executed. In an embodiment, each gate may be represented as a node or vertex in a DAG, and an estimate of a distribution of values may be obtained for each gate, or node, in the DAG.

The distributions obtained 302 may then be subjected to a binning process 304. In an embodiment, the binning 304 may represent the distributions as histograms. The bins of each distribution may create maps that may be used to quantize 306 the FP values of a matrix. In particular, a matrix value, such as an FP, may be represented by a respective bin index. In an embodiment, the distributions may be provided to a simulation engine as bin tables, and the FP values of the distributions then transformed, as part of the quantization 306, into respective bin indices. Because the bin indices may be substantially smaller in size than the FPs to which they correspond, only a relatively small amount of space may be needed to store 308 the bin indices.

Finally, a matrix multiplication, that is, a gate operation, may then be performed 310 using, or based upon, the bin indices. In an embodiment, only those matrix elements required for a matrix multiplication, such as a row of one matrix and column of the other matrix, may reside as FP values in memory, and the remaining matrix elements are represented in memory by respective bin indices.

### F. Further Example Embodiments

Following are some further example embodiments of the invention. These are presented only by way of example and are not intended to limit the scope of the invention in any way.

Embodiment 1. A method, comprising: obtaining, for a quantum gate of a quantum circuit, an estimate of a distribution of values expected to result from a matrix multiplication relating to the quantum gate; applying a binning process to the distribution to generate a bin table; quantizing an FP value of the matrix multiplication by mapping the bin table to a bin index that corresponds to the FP value; storing the bin index; and performing the matrix multiplication using the bin index.

Embodiment 2. The method as recited in any preceding embodiment, wherein the quantum gate is an element of a quantum circuit that is represented in a form of a directed acyclic graph.

Embodiment 3. The method as recited in any preceding embodiment, wherein the bin index requires less memory space for storage than is required by the FP value.

Embodiment 4. The method as recited in any preceding embodiment, wherein an estimate of a distribution of values is obtained, and a respective bin index generated, for each node of a quantum circuit directed acyclic graph that represents the quantum circuit, and each node corresponds to a gate of the quantum circuit.

Embodiment 5. The method as recited in any preceding embodiment, wherein the estimate is generated by a graph-based prediction engine.

Embodiment 6. The method as recited in any preceding embodiment, wherein the matrix multiplication is performed as part of a simulated execution of the quantum circuit on a classical computing infrastructure.

Embodiment 7. The method as recited in any preceding embodiment, wherein the estimate is obtained using a trained gated graph sequence neural network.

Embodiment 8. The method as recited in embodiment 1, wherein, as part of obtaining the estimate, a gated graph sequence neural network captures a relationship between inputs of a node of a directed acyclic graph representing the quantum circuit, and measured distributions obtained from executions, on a quantum simulation engine, of circuit directed acyclic graphs at full FP precision.

Embodiment 9. The method as recited in any preceding embodiment, wherein the estimate is obtained using a machine learning model that was trained using a loss function that measures a divergence between the estimated distribution and a measured real distribution resulting from running the quantum circuit multiple times.

Embodiment 10. The method as recited in any preceding embodiment, wherein a size of the bin index is variable to achieve a corresponding degree of precision in the quantizing.

Embodiment 11. The method as recited in any preceding embodiment, wherein the bin index is dequantized to the FP value to enable computation of a statistical measure of a bin to which the bin index corresponds, and dequantizing of the bin index is performed by a quantizer module of a simulation engine.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In general, embodiments may comprise classical, and/or quantum, hardware and/or software. Quantum hardware may include, for example, physical qubits and QPUs. Quantum circuits may comprise, for example, real and/or virtual qubits.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

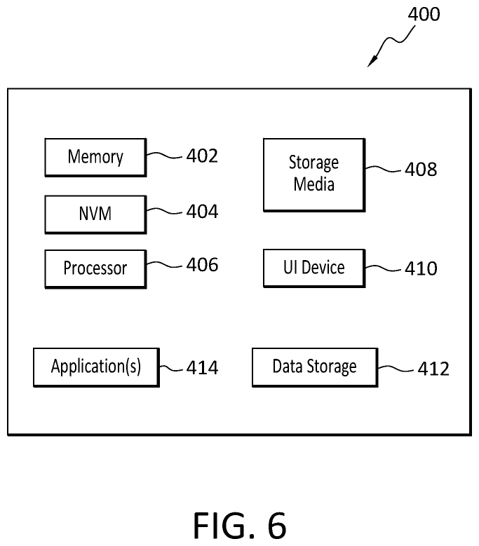

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 6.

In the example of FIG. 6, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
obtaining, for a quantum gate of a quantum circuit, an estimate of a distribution of values expected to result from a matrix multiplication relating to the quantum gate;
applying a binning process to the distribution to generate a bin table;
quantizing an FP value of the matrix multiplication by mapping the bin table to a bin index that corresponds to the FP value;
storing the bin index; and
performing the matrix multiplication using the bin index.

2. The method as recited in claim 1, wherein the quantum gate is an element of a quantum circuit that is represented in a form of a directed acyclic graph.

3. The method as recited in claim 1, wherein the bin index requires less memory space for storage than is required by the FP value.

4. The method as recited in claim 1, wherein an estimate of a distribution of values is obtained, and a respective bin index generated, for each node of a quantum circuit directed acyclic graph that represents the quantum circuit, and each node corresponds to a gate of the quantum circuit.

5. The method as recited in claim 1, wherein the estimate is generated by a graph-based prediction engine.

6. The method as recited in claim 1, wherein the matrix multiplication is performed as part of a simulated execution of the quantum circuit on a classical computing infrastructure.

7. The method as recited in claim 1, wherein the bin index is dequantized to the FP value to enable computation of a statistical measure of a bin to which the bin index corresponds, and dequantizing of the bin index is performed by a quantizer module of a simulation engine.

8. The method as recited in claim 1, wherein, as part of obtaining the estimate, a gated graph sequence neural network captures a relationship between inputs of a node of a directed acyclic graph representing the quantum circuit, and measured distributions obtained from executions, on a quantum simulation engine, of circuit directed acyclic graphs at full FP precision.

9. The method as recited in claim 1, wherein the estimate is obtained using a machine learning model that was trained using a loss function that measures a divergence between the estimated distribution and a measured real distribution resulting from running the quantum circuit multiple times.

10. The method as recited in claim 1, wherein a size of the bin index is variable to achieve a corresponding degree of precision in the quantizing.

11. A non-transitory storage medium having stored therein instructions that are executable by one or more hardware processors to perform operations comprising:
obtaining, fora quantum gate of a quantum circuit, an estimate of a distribution of values expected to result from a matrix multiplication relating to the quantum gate;
applying a binning process to the distribution to generate a bin table;
quantizing an FP value of the matrix multiplication by mapping the bin table to a bin index that corresponds to the FP value;
storing the bin index; and
performing the matrix multiplication using the bin index.

12. The non-transitory storage medium as recited in claim 11, wherein the quantum gate is an element of a quantum circuit that is represented in a form of a directed acyclic graph.

13. The non-transitory storage medium as recited in claim 11, wherein the bin index requires less memory space for storage than is required by the FP value.

14. The non-transitory storage medium as recited in claim 11, wherein an estimate of a distribution of values is obtained, and a respective bin index generated, for each node of a quantum circuit directed acyclic graph that represents the quantum circuit, and each node corresponds to a gate of the quantum circuit.

15. The non-transitory storage medium as recited in claim 11, wherein the estimate is generated by a graph-based prediction engine.

16. The non-transitory storage medium as recited in claim 11, wherein the matrix multiplication is performed as part of a simulated execution of the quantum circuit on a classical computing infrastructure.

17. The non-transitory storage medium as recited in claim 11, wherein the bin index is dequantized to the FP value to enable computation of a statistical measure of a bin to which the bin index corresponds, and dequantizing of the bin index is performed by a quantizer module of a simulation engine.

18. The non-transitory storage medium as recited in claim 11, wherein, as part of obtaining the estimate, a gated graph sequence neural network captures a relationship between inputs of a node of a directed acyclic graph representing the quantum circuit, and measured distributions obtained from executions, on a quantum simulation engine, of circuit directed acyclic graphs at full FP precision.

19. The non-transitory storage medium as recited in claim 11, wherein the estimate is obtained using a machine learning model that was trained using a loss function that measures a divergence between the estimated distribution and a measured real distribution resulting from running the quantum circuit multiple times.

20. The non-transitory storage medium as recited in claim 11, wherein a size of the bin index is variable to achieve a corresponding degree of precision in the quantizing.
